(19) United States
(12) Patent Application Publication
(10) Pub. No.: US 2013/0089796 A1
(43) Pub. Date: Apr. 11, 2013

(54) LITHIUM AIR BATTERY

(71) Applicants: Yang-Kook Sun, Seoul (KR); Hun-Gi Jung, Busan (KR)

(72) Inventors: Yang-Kook Sun, Seoul (KR); Hun-Gi Jung, Busan (KR)

(21) Appl. No.: 13/643,163

(22) PCT Filed: Apr. 27, 2011
(86) PCT No.: PCT/KR2011/003067

§ 371 Date: Dec. 21, 2012

(30) Foreign Application Priority Data
Apr. 27, 2010 (KR) 10-2010-0039203
Apr. 26, 2011 (KR) 10-2011-0039061

(51) Int. Cl. H01M 12/06

(52) U.S. Cl. CPC H01M 12/06
USPC 429/406; 429/405

(57) ABSTRACT

Disclosed is a lithium air battery that includes a positive electrode including a current collector and a positive active material layer disposed on the current collector and including a positive active material, a negative electrode including a negative active material, and an electrolyte, wherein the positive active material includes lithium peroxide (Li₂O₂), lithium oxide (Li₂O), lithium hydroxide (LiOH), or a combination thereof, and the negative active material includes a lithium metal alloy, a material being capable of doping and dedoping lithium, a transition element oxide, or a combination thereof.

### TECHNICAL FIELD

This disclosure relates to a lithium air battery.

### BACKGROUND ART

A lithium air battery has recently drawn attention as a power source for a portable electronic device, a hybrid car, and the like. Unlike a lithium ion battery, the lithium air battery produces energy by contacting lithium with air and has advantages of being easily being down-sized, lighter, and the like as well as having remarkably high energy density.

This lithium air battery is used by injecting an electrolyte in a battery can housing a positive electrode including a positive active material oxidizing and reducing lithium, and a negative electrode intercalating and deintercalating lithium.

The negative active material mainly includes a lithium metal. The lithium metal has a stability problem of being rapidly expanded when it contacts moisture and being rapidly oxidized and losing activity when it contacts air, which allows the lithium air battery to be commercially available and larger.

### DISCLOSURE

### Technical Problem

On exemplary embodiment of the present invention provides a lithium air battery having improved stability and thus being commercially available and having a large size.

### Technical Solution

According to one aspect of the present invention, a lithium air battery that includes a positive electrode including a current collector and a positive active material layer disposed on the current collector and including a positive active material, a negative electrode including a negative active material, and an electrolyte is provided, wherein the positive active material includes lithium peroxide (Li₂O₂), lithium oxide (Li₂O), lithium hydroxide (LiOH), or a combination thereof, and the negative active material includes a lithium metal alloy, a material being capable of doping and dedoping lithium, a transition element oxide, or a combination thereof.

The positive active material layer may further include a conductive material including a carbon-based material, a metal powder, a metal fiber, or a combination thereof, and the carbon-based material may include natural graphite, artificial graphite, carbon black, acetylene black, ketjen black, carbon fiber, carbon nanotubes, or a combination thereof.

The positive active material layer may further include a catalyst, the catalyst may include tricobalt tetroxide (Co₃O₄), manganese dioxide (MnO₂), cerium dioxide (CeO₂), platinum (Pt), gold (Au), silver (Ag), diiron trioxide (Fe₂O₃), triiron trioxide (Fe₃O₄), nickel monoxide (NiO), copper oxide (CuO), a perovskite catalyst, or a combination thereof, and the catalyst may be included in an amount of 1 to 50 wt % based on the total amount of the positive active material layer.

The positive active material may be included in an amount of 5 to 50 wt % based on the total amount of the positive active material layer.

The lithium metal alloy may include an alloy of lithium and a metal of Na, K, Rb, Cs, Fr, Be, Mg, Ca, Sr, Si, Sb, Pb, In, Zn, Ba, Ra, Ge, Al, Sn, or a combination thereof, the material being capable of doping and dedoping lithium may include Si, a Si-containing alloy, a Si—C composite, SiOₓ (0<x<2), Sn, a Sn-containing alloy, a Sn—C composite, SnO₂, or a combination thereof, and the transition elements oxide may include vanadium oxide, lithium vanadium oxide, titanium oxide, or a combination thereof.

The lithium air battery may be a swagelok type, a coin type, or a pouch type.

Other aspects of the present invention are included in the following detailed description.

### Advantageous Effects

Accordingly, the present invention may improve stability of a lithium air battery and thus realize commercial availability and a large size of the lithium air battery.

### DESCRIPTION OF THE DRAWINGS

FIG. 1 is a graph showing charge and discharge characteristics of the lithium air battery cell according to Example 1.

FIG. 2 is a graph showing charge and discharge characteristics of the lithium air battery cell according to Example 2.

FIG. 3 is a graph showing charge and discharge characteristics of the lithium air battery cell according to Comparative Example 1.

FIG. 4 is a graph showing charge and discharge characteristics of the lithium air battery cell according to Comparative Example 2.

### MODE FOR INVENTION

Exemplary embodiments will hereinafter be described in detail. However, these embodiments are exemplary, and this disclosure is not limited thereto.

Unless a specific description is not otherwise provided, it will be understood that when an element such as a layer, film, region, or substrate is referred to as being “on” another element, it can be directly on the other element or intervening elements may also be present. In contrast, when an element is referred to as being “directly on” another element, there are no intervening elements present.

A lithium air battery according to one embodiment includes a battery cell including a positive electrode, a negative electrode facing the positive electrode, a separator interposed between the positive electrode and negative electrode, and an electrolyte impregnated in the positive electrode, negative electrode, and separator.

The positive electrode includes a current collector and a positive active material layer formed on the current collector. The positive active material layer includes a positive active material.

The current collector includes aluminum (Al), nickel (Ni), iron (Fe), titanium (Ti), stainless steel, and the like, but is not limited thereto. The current collector may have a shape of a foil, sheet, mesh (or grid), foam (or sponge), and the like, and may preferably have shape of a foam (or sponge) having excellent current collecting efficiency.

The positive active material may include lithium peroxide (Li₂O₂), lithium oxide (Li₂O), lithium hydroxide (LiOH), or a combination thereof, and may preferably be lithium peroxide (Li₂O₂). The positive active material such as Li₂O₂ may be decomposed, and generates lithium ions during charge. The lithium ions move to a negative electrode and have a reaction of regenerating the positive active material such as Li₂O₂ during the discharge, improving stability of a lithium air battery.

The positive active material may be included in an amount of 5 to 50 wt % based on the total amount of the positive active material layer. When the positive active material is included within the amount range, a stable lithium air battery during the charge and discharge may be realized.

The positive active material layer may further include at least one of a conductive material, a catalyst, and a binder.

The conductive material is used to improve conductivity of an electrode, and any electrically conductive material may be used as a conductive material unless it causes a chemical change. Specific examples of the conductive material may include a carbon-based material, a metal powder, a metal fiber, or a combination thereof. The carbon-based material may preferably be one having a porous structure and a large specific surface area, examples thereof may be natural graphite, artificial graphite, carbon black, acetylene black, ketjen black, carbon fiber, carbon nanotubes, or a combination thereof, and the metal powder and metal fiber may be a metal of copper, nickel, aluminum, silver, and the like. At least one or more kinds of a conductive polymer such as a polyphenylene derivative may be mixed.

The conductive material may be included in an amount of 30 to 50 wt % based on the total amount of the positive active material layer. When the conductive material is included within the amount range, a stable lithium air battery during the charge and discharge may be realized.

The catalyst may be supported on the conductive material and helps decomposition of the positive active material, and examples thereof may be tricobalt tetroxide (Co₃O₄), manganese dioxide (MnO₂), cerium dioxide (CeO₂), platinum (Pt), gold (Au), silver (Ag), diiron trioxide (Fe₂O₃), triiron trioxide (Fe₃O₄), nickel monoxide (NiO), copper oxide (CuO), a perovskite catalyst, or a combination thereof.

The catalyst may be included in an amount of 1 to 50 wt % based on the total amount of the positive active material layer. When the catalyst is included within the amount range, a positive active material may be smoothly decomposed, realizing a stable lithium air battery during the charge and discharge.

The binder improves binding properties of positive active material particles with one another and with a current collector, and examples thereof may include polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The binder may be included in an amount of 5 to 30 wt % based on the total amount of the positive active material layer. When the binder is included within the amount range, a stable lithium air battery during the charge and discharge may be realized.

The positive electrode is exposed to the air during the fabrication of a lithium air battery. When the positive electrode is exposed to the air, oxygen generated due to decomposition of the positive active material is released out of the lithium air battery, which prevents the oxygen from oxidizing an electrolyte. In addition, the released oxygen may prevent explosion caused by a small spark and the like and volume expansion of the lithium air battery.

The negative electrode includes a current collector and a negative active material layer formed on the current collector. The negative active material layer includes a negative active material.

The current collector may include a copper foil, a nickel foil, a stainless steel foil, a titanium foil, a nickel foam, a copper foam, a polymer substrate coated with a conductive metal, and combinations thereof, but is not limited thereto.

The negative active material may include a lithium metal alloy, a material being capable of doping and dedoping lithium, a transition element oxide, or a combination thereof. The negative active material may remarkably increase stability of a lithium air battery compared to a lithium metal.

The lithium metal alloy may be an alloy of lithium and a metal of Na, K, Rb, Cs, Fr, Be, Mg, Ca, Sr, Si, Sb, Pb, In, Zn, Ba, Ra, Ge, Al, Sn, or a combination thereof.

The material being capable of doping and dedoping lithium may include Si, a Si—C composite, SiOₓ (0<x<2), a Si—Y alloy (wherein Y is an alkali metal, an alkaline-earth metal, Group 13 to 16 elements, a transition element, a rare earth element, or a combination thereof, and not Si), Sn, a Sn—C composite, SnO₂, a Sn—Y alloy (wherein Y is an alkali metal, an alkaline-earth metal, Group 13 to 16 elements, a transition element, a rare earth element, or a combination thereof, and not Sn), and the like, and at least one of these materials may be mixed with SiO₂. The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The negative active material has higher theoretical capacity and theoretical density than a carbon-based material, and may realize a lithium air battery having excellent energy density.

Among the negative active materials, the material being capable of doping and dedoping lithium may be preferably used, and the Si—C composite or Sn—C composite may be more preferably used. The negative active material has a relatively lower voltage range and relatively higher capacity and stable cycle-life characteristic, and thus may realize a lithium air battery having high energy density.

The transition elements oxide may include vanadium oxide, lithium vanadium oxide, titanium oxide, or a combination thereof, but is not limited thereto.

The negative active material may be included in an amount of 30 to 95 wt % based on the total amount of the negative active material layer. When the negative active material is included within the amount range, a stable lithium air battery during the charge and discharge may be realized.

The negative active material layer may further include at least one of a conductive material and a binder.

The conductive material is used to improve conductivity of an electrode, and any electrically conductive material may be used as a conductive material unless it causes a chemical change. Specific examples of the conductive material may include a carbon-based material, a metal powder, a metal fiber, or a combination thereof. The carbon-based material may include natural graphite, artificial graphite, carbon black, acetylene black, ketjen black, a carbon fiber, or a combination thereof, and the metal powder and metal fiber may be a metal of copper, nickel, aluminum, silver, and the like. At least one or more kinds of a conductive polymer such as a polyphenylene derivative may be mixed therein.

The conductive material may be included in an amount of 1 to 50 wt % based on the total amount of the negative active material layer. When the conductive material is included within the amount range, a stable lithium air battery during the charge and discharge may be realized.

The binder improves binding properties of negative active material particles with one another and with a current collector, and examples thereof may include polyvinyl alcohol, carboxylmethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The binder may be included in an amount of 3 to 30 wt % based on the total amount of the negative active material layer. When the binder is included within the amount range, a stable lithium air battery during the charge and discharge may be realized.

The positive electrode and the negative electrode may be manufactured by mixing each active material, a conductive material, and a binder in a solvent to prepare an active material composition, and applying the composition on a current collector. The positive electrode is exposed to the air during fabrication of a lithium air battery.

The electrode manufacturing method is well known, and thus is not described in detail in the present specification. The solvent includes N-methylpyrrolidone and the like, but is not limited thereto.

The separator may be a single layer or multilayer, and may be made of, for example, polyethylene, polypropylene, polyvinylidene fluoride, or a combination thereof.

The electrolyte may be a solid electrolyte or a liquid electrolyte.

The solid electrolyte may use polyethylene oxide, polypropylene oxide, polyacrylonitrile, polyvinylidene fluoride, or a combination thereof.

The liquid electrolyte may use a non-aqueous organic solvent.

The non-aqueous organic solvent plays a role of transmitting ions taking part in the electrochemical reaction of a battery. The non-aqueous organic solvent may include a carbonate-based, ester-based, ether-based, ketone-based, alcohol-based, or aprotic solvent.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), and the like.

The ester-based solvent may include, for example methylacetate, ethylacetate, n-propylacetate, dimethylacetate, methylpropinonate, ethylpropinonate, γ-butyrolactone, decanolide, valerolactone, mevalonolactone, caprolactone, and the like. The ether-based solvent may include, for example dibutylether, tetraglyme, diglyme, dimethoxyethane, 2-methyltetrahydrofuran, tetrahydrofuran, and the like, and the ketone-based solvent may include cyclohexanone and the like. The alcohol-based solvent may include ethanol, isopropyl alcohol, and the like.

The non-aqueous organic solvent may use tetraethylene glycol dimethylether, ethylene glycol dimethacrylate, polyethylene glycol, polyethylene glycol dialkyl ether, polyalkyl glycol dialkyl ether, or a combination thereof.

The non-aqueous organic solvent may be used singularly or in a mixture. When the organic solvent is used in a mixture, its mixture ratio can be controlled in accordance with desirable performance of a battery.

The electrolyte may include a lithium salt.

The lithium salt dissolved in the non-aqueous organic solvent supplies lithium ions in the battery, operates a basic operation of a lithium air battery, and improves lithium ion transport between positive and negative electrodes.

Examples of the lithium salt may include LiPF₆, LiBF₄, LiSbF₆, LiAsF₆, LIN(SO₃C₂F₆)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, Lil, LiB(C₂O₄)₂ (lithium bis(oxalato) borate; LiBOB), or a combination thereof.

The lithium salt is preferably used at a concentration of about 0.1 M to about 2.0 M. When the lithium salt is included at the above concentration range, electrolyte performance and lithium ion mobility may be enhanced due to optimal electrolyte conductivity and viscosity.

The lithium air battery may be manufactured in a form of a swagelok type, and may be manufactured in a form of a coin, pouch, and the like.

The following examples illustrate the present invention in more detail. These examples, however, should not in any sense be interpreted as limiting the scope of the present invention.

A person having ordinary skill in this art can sufficiently understand parts of the present invention that are not specifically described.

### Manufacture of Lithium Air Battery Cell

### Example 1

28 mmol of resorcinol (Aldrich-Sigma Co. Ltd.) was mixed with 120 mmol of formaldehyde (a 37% aqueous solution, Aldrich-Sigma Co. Ltd.), and sodium carbonate and resorcinol were added to the solution in a mole ratio of 45:100. The resulting solution was mixed at 75° C. for 1 hour to obtain a gel mixture. The gel mixture was aged at room temperature for 24 hours. The aged mixture was washed with water and ethanol to remove the sodium carbonate therein. The obtained structure was dipped in a tributylphenyltin (Aldrich-Sigma Co. Ltd.) solution for a day and heat-treated at 700° C. for 2 hours under an Ar atmosphere, preparing a Sn—C composite.

The Sn—C composite powder was mixed with polyvinylidene fluoride (PVdF) and carbon black (super P) in a weight ratio of 80:10:10, and the mixture was dispersed into N-methyl-2-pyrrolidone, preparing a negative active material layer composition. The negative active material layer composition was coated on a copper foil. The resulting product was dried in a 100° C. oven for 2 hours and vacuum-dried for greater than or equal to 12 hours, fabricating a negative electrode.

On the other hand, a positive active material layer composition was prepared by mixing lithium peroxide (Li₂O₂), polyvinylidene fluoride (PVdF), and carbon black (super P) in a weight ratio of 45:10:45 and dispersing the mixture into N-methyl-2-pyrrolidone. The positive active material layer composition was casted on an aluminum mesh, and the casted mesh was dried in a 100° C. oven for 2 hours and vacuum-dried for greater than or equal to 12 hours, fabricating a positive electrode.

The negative and positive electrodes were used with a porous polyethylene film separator (Celgard 3501, Celgard LLC), fabricating a swagelok-type lithium air battery cell. Herein, the positive electrode might have a hole for passing oxygen. Then, an electrolyte prepared by mixing ethylene carbonate (EC) and dimethyl carbonate (DMC) in a volume ratio of 3:7 and dissolving LiPF₆ at a concentration of 1 M was injected between the positive and negative electrodes.

### Example 2

Si powder having a size of 100 nm and natural graphite powder having a size of 5 μm were mixed in a weight ratio of 30:70, and the mixture was added to a tetrahydrofuran solution. Next, 33 parts by weight of pitch was added to 100 parts by weight of the mixed solution. The mixture was ball-milled for 12 hours. The mixed solution was dried in a 100° C. vacuum oven for 6 hours and heat-treated at 1000° C. for 5 hours under an Ar atmosphere, fabricating a Si—C composite.

The Si—C composite powder was mixed with carbon black (super P), carboxylmethyl cellulose, and styrene-butadiene rubber in a weight ratio of 85:5:3.3:6.7 in water, preparing a negative active material layer composition. The negative active material layer composition was casted on a copper foil, and the casted foil was dried in a 100° C. oven for 2 hours and vacuum-dried for greater than or equal to 12 hours, fabricating a negative electrode.

On the other hand, a positive active material layer composition was prepared by mixing lithium peroxide (Li₂O₂), polyvinylidene fluoride (PVdF), and carbon black (super P) in a weight ratio of 45:10:45 and dispersing the mixture into N-methyl-2-pyrrolidone. The positive active material layer composition was casted on an aluminum mesh, and the casted mesh was dried in a 100° C. oven for 2 hours and vacuum-dried for greater than or equal to 12 hours, fabricating a positive electrode.

The negative and positive electrodes were used with a porous polyethylene film separator (Celgard 3501, Celgard LLC), fabricating a swagelok-type lithium air battery cell. Herein, the positive electrode might have a hole for passing oxygen. Then, an electrolyte prepared by mixing ethylene carbonate (EC) and dimethyl carbonate (DMC) in a volume ratio of 3:7 and dissolving LiPF₆ at a concentration of 1 M was injected between the positive and negative electrodes.

### Comparative Example 1

A positive active material layer composition was prepared by mixing lithium peroxide (Li₂O₂), polyvinylidene fluoride (PVdF), and carbon black (super P) in a weight ratio of 45:10:45 and dispersing the mixture into N-methyl-2-pyrrolidone. The positive active material layer composition was coated on a nickel foam current collector, dried, and compressed, fabricating a positive electrode.

On the other hand, a negative active material layer composition was prepared by mixing artificial graphite (MCMB), polyvinylidene fluoride (PVdF), and carbon black (super P) in a weight ratio of 92:5:3 and dispersing the mixture into N-methyl-2-pyrrolidone. The negative active material layer composition was coated on a 15 μm-thick copper foil, dried, and compressed, fabricating a negative electrode.

The negative and positive electrodes were used with a porous polyethylene film separator (Celgard 3501, Celgard LLC) to fabricate a swagelok-type lithium air battery cell. Herein, the positive electrode might have a hole for passing oxygen. Then, an electrolyte was prepared by mixing ethylene carbonate (EC) and dimethyl carbonate (DMC) in a volume ratio of 3:7 and dissolving LiPF₆ at a concentration of 1 M therein, and was then injected between the positive and negative electrodes.

### Comparative Example 2

A lithium air battery cell was fabricated according to the same method as Comparative Example 1, except for fabricating a positive electrode by mixing lithium peroxide (Li₂O₂), polyvinylidene fluoride (PVdF), and carbon black (super P) supported by a catalyst MnO₂ (5 parts by weight based on 100 parts by weight of carbon black) in a weight ratio of 45:10:45.

### Experimental Example 1

### Electrochemical Performance of Lithium Air Battery

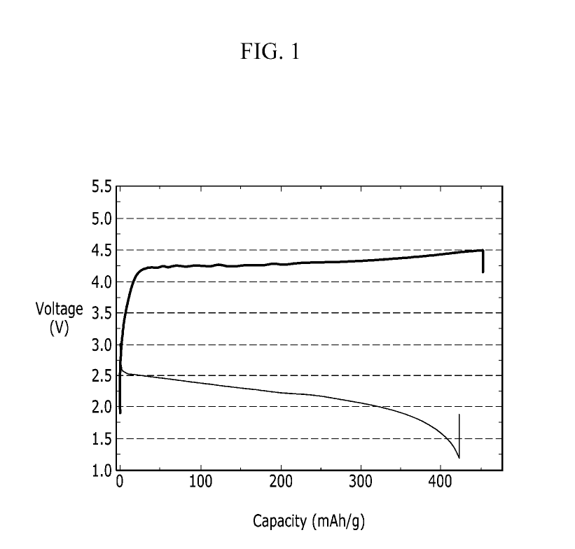

The lithium air battery cells according to Examples 1 and 2 and Comparative Examples 1 and 2 were evaluated regarding charge and discharge characteristics to evaluate electrochemical performance. The results are provided in FIGS. 1 to 4.

The lithium air battery cell according to Example 1 was put in a chamber filled with oxygen and charged and discharged once at 1.2 to 4.5 V under a current condition of 10 mA/g. In addition, the lithium air battery cell according to Example 2 was charged and discharged once at 2.0 to 4.5 V under a current condition of 5 mAh/g. Furthermore, the lithium air battery cells according to Comparative Examples 1 and 2 were charged and discharged once at 2.0 to 4.1 V under a current condition of 10 mAh/g.

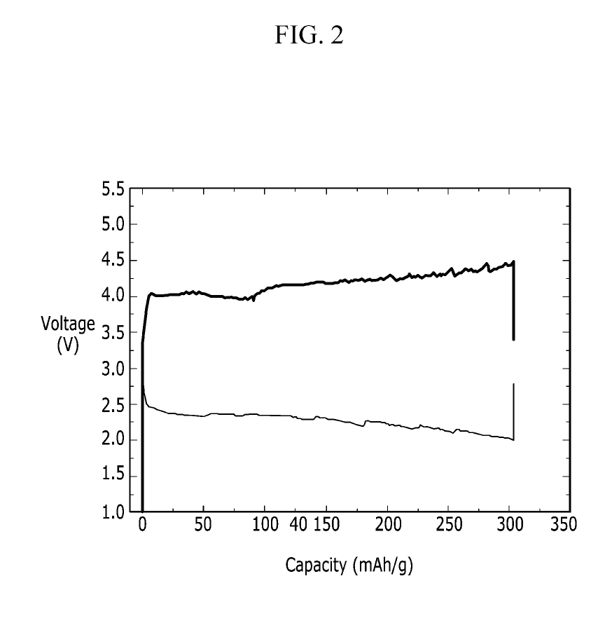

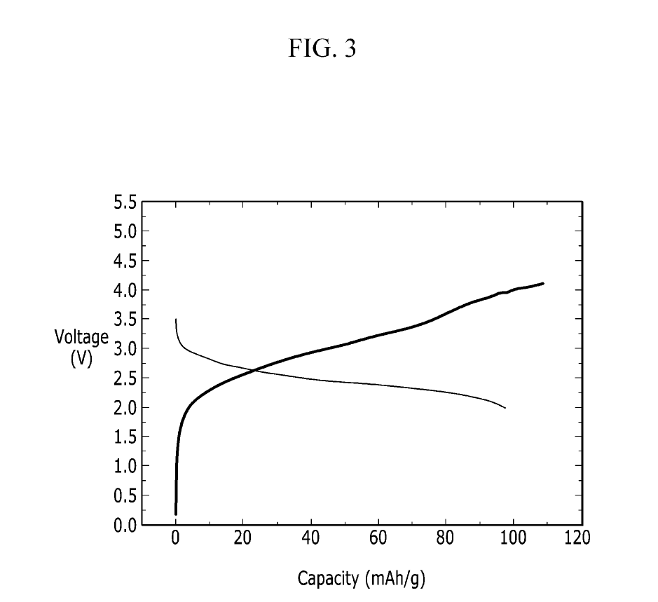

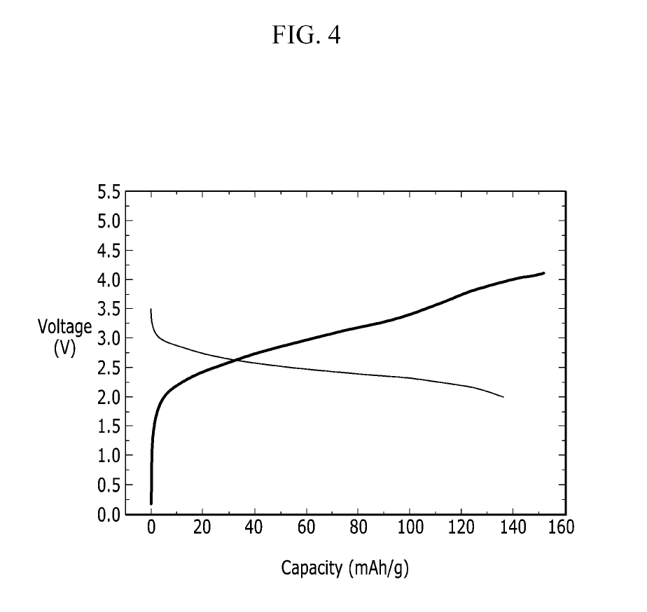

FIG. 1 is a graph showing charge and discharge characteristics of the lithium air battery cell according to Example 1, FIG. 2 is a graph showing charge and discharge characteristics of the lithium air battery cell according to Example 2, FIG. 3 is a graph showing charge and discharge characteristics of the lithium air battery cell according to Comparative Example 1, and FIG. 4 is a graph showing charge and discharge characteristics of the lithium air battery cell according to Comparative Example 2.

Referring to FIGS. 1 to 4, the lithium air battery cell using lithium peroxide (Li₂O₂) as a positive active material and a Sn—C composite as a negative active material according to Example 1 and the lithium air battery cell using lithium peroxide (Li₂O₂) as a positive active material and a Si—C composite as a negative active material according to Example 2 had excellent charge and discharge characteristics compared with the lithium air battery cells using a carbon-based compound as a negative active material according to Comparative Examples 1 and 2.

Therefore, a lithium air battery according to the present invention turned out to have excellent stability.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A lithium air battery, comprising:
a positive electrode including a current collector and a positive active material layer disposed on the current collector and including a positive active material;
a negative electrode including a negative active material; and
an electrolyte,
wherein the positive active material comprises lithium peroxide (Li₂O₂), lithium oxide (Li₂O), lithium hydroxide (LiOH), or a combination thereof, and
the negative active material comprises a lithium metal alloy, a material being capable of doping and dedoping lithium, a transition element oxide, or a combination thereof.

2. The lithium air battery of claim 1, wherein the positive active material layer further comprises a conductive material including a carbon-based material, a metal powder, a metal fiber, or a combination thereof.

3. The lithium air battery of claim 2, wherein the carbon-based material comprises natural graphite, artificial graphite, carbon black, acetylene black, ketjen black, carbon fiber, carbon nanotubes, or a combination thereof.

4. The lithium air battery of claim 1, wherein the positive active material layer further comprises a catalyst.

5. The lithium air battery of claim 4, wherein the catalyst comprises tricobalt tetroxide (Co₃O₄), manganese dioxide (MnO₂), cerium dioxide (CeO₂), platinum (Pt), gold (Au), silver (Ag), diiron trioxide (Fe₂O₃), triiron trioxide (Fe₃O₄), nickel monoxide (NiO), copper oxide (CuO), a perovskite catalyst, or a combination thereof.

6. The lithium air battery of claim 4, wherein the catalyst is included in an amount of 1 to 50 wt % based on the total amount of the positive active material layer.

7. The lithium air battery of claim 1, wherein the positive active material is included in an amount of 5 to 50 wt % based on the total amount of the positive active material layer.

8. The lithium air battery of claim 1, wherein the lithium metal alloy comprise an alloy of lithium and a metal of Na, K, Rb, Cs, Fr, Be, Mg, Ca, Sr, Si, Sb, Pb, In, Zn, Ba, Ra, Ge, Al, Sn, or a combination thereof.

9. The lithium air battery of claim 1, wherein the material being capable of doping and dedoping lithium comprises Si, a Si-containing alloy, a Si—C composite, SiOₓ (0<x<2), Sn, a Sn-containing alloy, a Sn—C composite, SnO₂, or a combination thereof.

10. The lithium air battery of claim 1, wherein the transition elements oxide comprises vanadium oxide, lithium vanadium oxide, titanium oxide, or a combination thereof.

11. The lithium air battery of claim 1, wherein the lithium air battery is a swagelok type, a coin type, or a pouch type.
